(19) United States
(12) Patent Application Publication
(10) Pub. No.: US 2005/0177431 A1
(43) Pub. Date: Aug. 11, 2005

(54) Broker system for combining computer gaming and advertising

(76) Inventors: Daniel Willis, Ottawa (CA); Dhananjay Godse, Ottawa (CA)

Correspondence Address: FREEDMAN & ASSOCIATES, 117 CENTREPOINTE DRIVE, SUITE 350, NEPEAN, ONTARIO, K2G 5X3, CA

(21) Appl. No.: 11/055,175

(22) Filed: Feb. 11, 2005

Related U.S. Application Data
(60) Provisional application No. 60/543,267, filed on Feb. 11, 2004.

(51) Int. Cl. G06F 17/60

(52) U.S. Cl. 705/14; 705/1

(57) ABSTRACT

Disclosed is a broker mediated advertisable gaming environment. The gaming environment communicates with a broker or a server, the broker or server site maintains an inventory of characteristics of registered games, the characteristics relevant for advertising. When a broker is communicated with, the system has gaming sites and advertising sites connected to an access aggregation network and the broker site is connected to the access aggregation network for registering games provided from gaming sites and for licensing registered games for advertising to advertising sites.

This application claims benefit from U.S. Provisional application 60/543,267 filed Feb. 11, 2004.

### FIELD OF THE INVENTION

The instant invention generally relates to advertising on the Internet, and more specifically to a system and a method combining Internet computer gaming with Internet advertising.

### BACKGROUND OF THE INVENTION

Since the concept of the World Wide Web (WWW) was conceived in the early nineties of the last century, and since the official release of the first Mosaic browser in February 1993, which looks like an archaic relict in comparison with current systems and yet enabled easy access to the about 50 HTML servers known at that time proving the workability of the WWW concept and spawning a plethora of new and improving activities, that what is commonly known as “the Web” and what already has to be classified as the medium of the 21^{st} century, has influenced and changed all aspects of moderm social as well as business life in a hitherto unknown dramatic fashion.

One of the areas concerned with our modem social life that has received major impulses from WWW related developments, is computer gaming. Since its origins, dating back to the early seventies of the last century, computer gaming did not only undergo a period of substantial growth, but also radically changed its role in social interactions and interpersonal relationships. In our modem world, the computer gamer is no longer an isolated and introverted individual, but is part of a rich and active community of like-minded people. In recent times, the ongoing developments in the field of computer gaming led to the creation of new and exciting markets, as for example on-line computer gaming. The rapid expansion of the Internet provides not only the basis, but also the boost for the constant developments in on-line computer gaming.

During the last couple of years, on-line computer gaming has gained increasing popularity, and today thousands of players are playing on-line all around the world. Many people stereotype this group as techno kids only, but this could not be more wrong. Both females and males of all ages can be found daily trying to out-think, out-maneuver, or just having a good time on-line. On the Eve of the Electronic Entertainment Expo (E3Expo), the world's largest trade event showcasing computer and video games and related products, a new survey by Peter D. Hart Research Associates, Inc., has found that three-in-five Americans age six or older, or about 145 million people, say they routinely play computer or video games, and that nearly half of these game players are female. Predictably, interactive on-line computer gaming will blur the line between games and other entertainment or communication media, and the avenues explored in the development of on-line gaming might well break new ground for interactive Internet applications in all areas of business relations and social life.

However, besides all the positive features associated with the WWW, the Internet has its own share of problems as well. The general attitude towards the Internet exhibited by the common user of its services is that the Internet is free of charge, apart from minimal connection fees for the access provider. This as a consequence causes a considerable financial burden for many professional providers not of Internet access, but of Internet services. A common solution to this problem is Internet advertisement. Advertising holds the promise to be the ticket to prosperity for many Internet services. For an advertiser, the value of advertising is the ability to direct an advertisement to a specific group of consumers. Control over the advertisement in terms of when, where, how, and to whom an advertisement is communicated is of paramount importance to the advertiser. Targeted advertising, which offers compelling content aimed at a specific demographic market, will be the future in Internet advertising.

Until the present, the main efforts in Internet advertising have been directed towards placing advertisements within specific websites. Many of the current systems and methods for Internet advertising are designed having in mind Internet service providers as main users. However, a new form of advertising is presently evolving, the so-called interactive advertising. Interactive advertising is the paid and unpaid presentation and promotion of products, services and ideas by an identified sponsor through mediated processes involving mutual action between consumers and producers. Interactive advertising is a step closer to real communications; it is bi-directional, personalized, and shifts control to the customers' side, which is the main paradigm shift from traditional advertising. Whereas conventional methods for advertisement on the Internet are static, the new interactive methods are highly dynamic.

Due to their dynamic nature as well as due to their specific appeal to certain audiences, computer games and especially Internet games provide the ideal vehicle for Internet advertising. Not only is it possible for an advertiser to directly target a specific group of customers, but advertisements can be directly incorporated into the computer games, enabling an equivalent to the well-known concept of product placement. It would therefore be highly advantageous to have at hand a system for effectively combining the two concepts elucidated above, and thus building a bridge from the advertising world to the world of computer gaming.

### SUMMARY OF THE INVENTION

It is an advantage of the instant invention that the system and method linking advertising sites with gaming sites allows for specific and dynamic combination of targeted advertisements with a proper advertising environment.

In accordance with an aspect of the instant invention there is provided a broker mediated advertisable gaming environment having gaming sites and advertising sites connected to an access aggregation network. The gaming environment comprises a broker site connected to an access aggregation network for registering games provided from gaming sites and for licensing registered games for advertising to advertising sites, whereby the broker site maintains an inventory of characteristics of registered games, the characteristics relevant for advertising.

In accordance with another aspect of the instant invention there is provided a method for spot management within an advertisable gaming environment comprising the steps of providing a game comprising a plurality of spots, registering a game comprising a plurality of spots with a broker site, and enabling a subset of spots for advertising. Optionally, the method further comprises the steps of disabling a subset of spots for advertising; and enabling another subset of spots for advertising.

In accordance with another aspect of the instant invention there is provided a method for automatically registering a game within the broker mediated gaming environment comprising the steps of a previously unregistered game identifying itself to the broker site, the broker site accepting and registering the new game and its plurality of spots, and enabling a subset of spots for advertising. Optionally, the method further comprises the steps of utilizing a template for the automatic generation of necessary and optional data in the registration of the game based on default criteria. Optionally, the method further comprises the steps of notifying an advertising site of the newly registered game and offering it for lease for provision of advertising content.

In accordance with another aspect of the instant invention there is provided a method for automatically registering and provisioning previously unregistered spots for advertising with the broker site within the broker mediated gaming environment comprising the steps of the game requesting content for a spot, the game recognizing the spot has not been registered in the inventory of the spots associated with this game at the broker site, the game requesting automatic registration of the new spot within the broker site, the broker creating the new spot within the inventory associated with the game at the broker site. Optionally, the method further comprises the step of creating the new spot based on criteria supplied by the game during the automatic registration request. Optionally, the method further comprises the step of defining an automatically registered spot based on default criteria specified by a template associated with the game producer or the game. Optionally, the method further comprises the steps of automatically enabling the spot for advertising, notifying the advertising site currently associated with the game that new advertising spots are available. Optionally, method further comprises the steps of the notified advertising site associating appropriate advertising content with the spot based on a set of pre-approved advertising content which matches the criteria for the newly created spots, when the next request for advertising content comes from a gaming site representing the game in question, the newly associated advertising content is delivered for presentation within the newly registered advertising spots.

### BRIEF DESCRIPTION OF THE DRAWINGS

Embodiments of the instant invention will now be described in conjunction with the following drawings, in which

FIG. 1 displays a schematic diagram illustrating connections and interactions between various sites connected over a network and related to advertising and gaming in accordance with an embodiment of the instant invention;

FIG. 2 schematically illustrates the build-up of an entry for a registered game in the broker inventory in accordance with an embodiment of the instant invention;

FIG. 3 displays a flow chart illustrating a method of spot management in accordance with an embodiment of the instant invention;

FIG. 4 is a simplified flow diagram of a method of delivering content to spots from a server;

FIG. 5 is a simplified diagram of a user entry interface for modifying characteristics of a spot;

FIG. 6 is a simplified flow diagram of a method of modifying characteristics associated with spots;

FIG. 7 illustrates the messaging sequence involved with the method of automatically registering a game and spots therein with a database of a broker or with a database of a server; and,

FIG. 8 illustrates the messaging sequence involved with the method of automatically, creating and provisioning spots within a game with a database of the broker or with a database of a server.

### DETAILED DESCRIPTION OF THE INVENTION

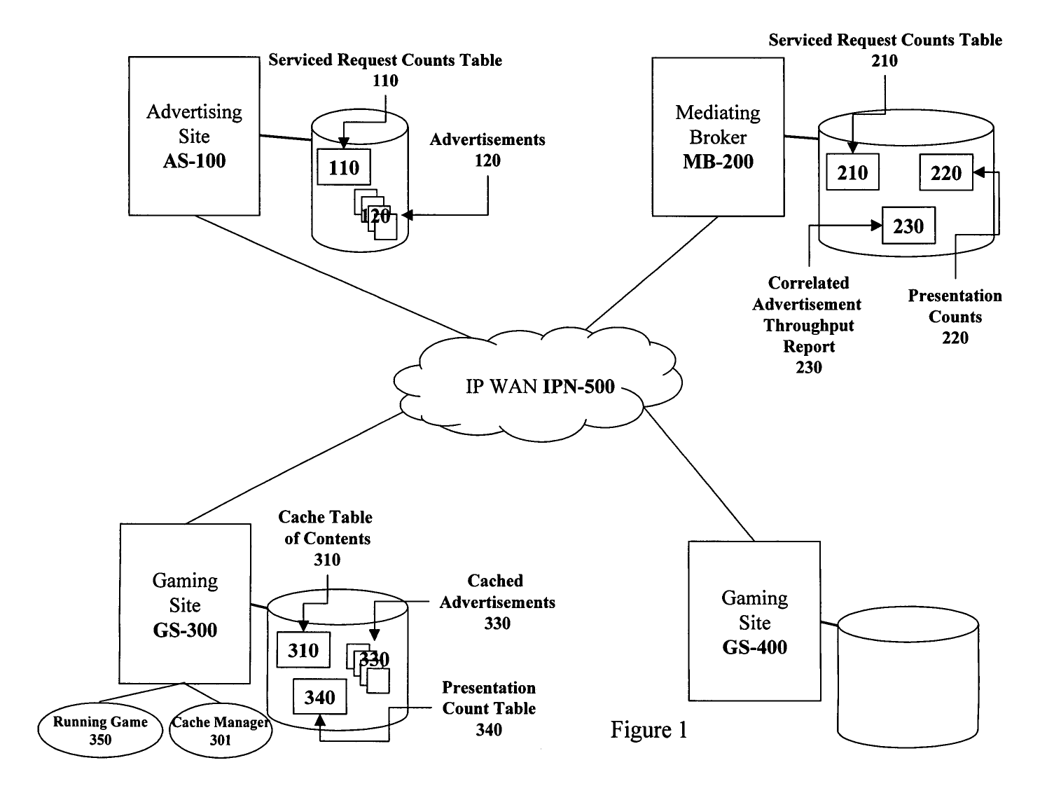

Embodiments of the instant invention are now described, all of which relate to the combination of advertising activities and gaming activities on the Internet. Referring now to FIG. 1, shown is a schematic diagram of a broker mediated advertisable gaming environment. The schematic diagram of Figure illustrates the single components of the broker mediated advertisable gaming environment, as well as different modes of interaction therebetween. The broker mediated advertisable gaming environment comprises an advertising site, a gaming site, as well as a broker bridge. The common linking medium establishing communication between the single components is an access aggregation network AAN 100. The access aggregation network AAN 100 generally is a wide area network WAN, and preferably a broadband access network BAN. Physical connections 101 provide access for the single components to the AAN 100.

On the advertising site, there is provided a reach engine RE 110. The reach engine RE 110 constitutes an advertisement service provider, and administers an inventory of different advertisements, which preferably are targeted to a specific group of customers.

On the gaming site, there is provided a game producer GP 120. The game producer produces new games, and preferably advertisable games. An advertisable game is a game that supports advertising within the gaming context. The advertisement is possibly displayed when a game is not being played, but for example is being loaded, or it is embedded into the gaming environment. Further preferably, advertisable games comprise a plurality of spots. A spot is an area within the gaming environment, which is reserved for the display of an advertisement. Initialized by generic content, a spot is populated with specific advertisements when a game is played. For example, an available spot within a game is associated with a T-shirt worn by the hero in the game. The available spot is initialized so that the hero of the game wears a shirt, which has emblazoned thereon the name of the game. When becoming an enabled spot the hero of the game for example wears a shirt, which has emblazoned thereon the mascot of a popular cereal manufacturer, the game being targeted towards an audience in the age span between eight and twelve years.

Also connected to the ANN 100 are single user sites 130. A single user sites is primarily characterized as being part of the gaming site, yet since advertisements are displayed within devices located at the single user sites, also exhibits certain advertising site characteristics. Located at a single user site 130 is a gaming console GC 133 in connection with at least a display device 1331 such as a monitor, at least an interaction device 1332 such as a keyboard or a joystick, and at least a data storage device 1333 such as a compact disc.

Another component connected to the AAN 100 is an advertising broker AB 140. The advertising broker AB 140 constitutes a bridge between the advertising site and the gaming site. The AB 140 comprises an inventory 150, which contains characteristics of registered games. For each registered game, there exists a unique inventory entry. If there is no characteristic information for a registered game available, the entry in the inventory 150 is referred to as null inventory.

Still with reference to FIG. 1, the interactions between the single components of the above-described gaming/advertising environment are now explained. The GP 120 produces new games and sells the game to a single user site 130, indicated by interaction-arrow 201.

Further, the GP 120 registers the game and selected spots with the AB 140, indicated by interaction-arrow 202. For example, the GP 120 selects a certain number of spots all implemented within a game for registration with the AB 140. Registering a game with the AB 140 makes the game available for licensing by an advertisement service provider, and registering a spot means that the spot is a potential field for advertising. Spots are typically characterized as available spots and/or enabled spots, as hard spots or as soft spots.

Available Spots are all the spots that are implemented within a particular game. Preferably, the available spots are initialized with generic content. Optionally, the available spots are invisibly embedded within a gaming environment. That what looks like another detail adding color and character to a certain gaming scenario might well turn into a spot at which advertisements appear.

Enabled Spots are spots selected by the GP 120, and registered with the AB 140. Depending on external characteristics, the GP 120 preferably changes a selection of enabled spots. It is likely not a good strategy to enable all of the available spots, turning a game into an advertisement heavy environment, which in turn lessens the acceptance within a community of gamers. However, a selection of enabled spots might for example be seasonal influenced. A GP 120 of an adventure game having gaming scenarios located at the ocean as well as in the mountains is likely to enable spots within the ocean scenes during the summer months to provide an ideal environment for swimsuit advertisements, and is likely to enable spots within the mountain scenes during the winter months to accustom advertisements directed towards skiing and snowboarding.

Hard Spots are spots, which possess unchangeable characteristics. Certain spots might prove to provide the possibility of trademark advertising within a game, and advertisements related to such spots are perceived as characteristic feature of a particular game. For example, beer commercials are often designed with a particular group of people in mind, not only advertising a beverage, but lifestyle and attitude as well. It is likely that certain sport games are therefore connected to a particular brand of beer, and an advertisement for this particular brand of beer is likely to develop into a characteristic feature of this particular game. It is thus likely that the GP 120 creates a hard spot for beer advertising within the game. A person of skill in the art understands to apply this concept to other types of products, which lend themselves to hard-spot advertising.

Soft Spots are spots, which are to be enabled and disabled during the registration life of a game. When a new game enters the gaming market, nothing is known yet about the acceptance of this particular game within a gaming community. The GP 120 designs and implements a large number of available spots, and begins to register a certain number of spots with the AB 140. Depending on the impact of a certain advertisement appearing in a particular spot, this spot is either maintained when the advertisement is a high-impact advertisement, or it is disabled in favor for another spot, when the advertisement is a low-impact advertisement.

Still with reference to FIG. 1, the RE 110 licenses a game with the AB 140, indicated by interaction-arrow 203. Preferably, the RE 110 licenses a game for a given period of time. Located at the RE is a catalog of advertisements, and based on the entry of a registered game in the inventory 150, the RE assigns certain advertisements to particular spots of certain games. Using the characteristic inventory entry of a registered game, and using predefined target characteristics of an advertisement out of the catalog of advertisements, a mapping between possible enabled spots and advertisements for display within these spots is established.

A user located at the single user site 130 purchases a game from GP 120, and connects to the AAN 100 to play the game with likeminded individuals. The gaming software is loaded onto GC 133.The gaming software is either loaded from a storage medium such as a compact disc, or it is loaded over the AAN 100. The interplay between a single user site 130 with other single user sites over the AAN 100 is indicated by interaction arrow 204. The gaming activities of a single user site typically refer to interactive gaming, but are not restricted thereto. An interactive gaming scenario is characterized by the situation that one user plays interactively together with or against other users. The gaming software establishes the exchange of gaming related information between all the users involved in a certain gaming situation. Typically, in this gaming scenario, the user utilizes a particular gaming console 133, especially equipped with hardware and software requirements for advanced graphics, enhanced sound support, and the like, and retrieves information regarding a particular game situation from the gaming software. This way, a truly interactive gaming experience is achieved.

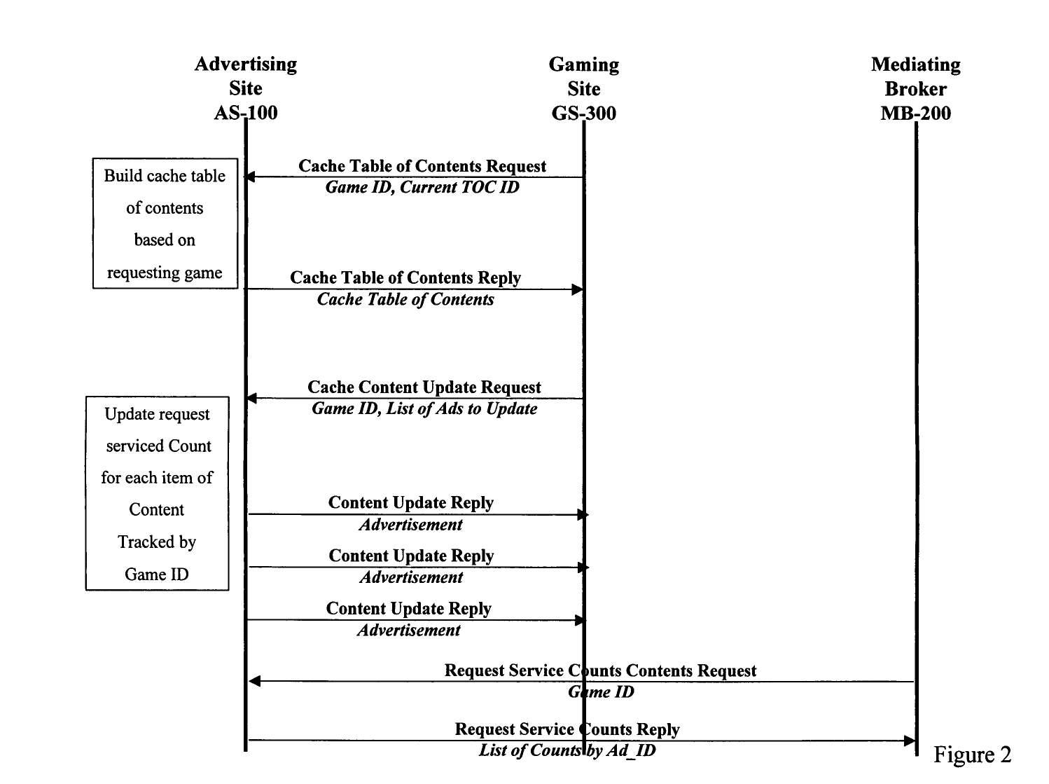

Referring now to FIG. 2, the make-up of an entry of a registered game in the inventory 150 is displayed. The entry is divided into fields referring to so-called spotted information as well as spotless information. Spotted information field 151 refers to information about the advertising spots of a registered game, and is subdivided into field 1511 containing a listing of enabled spots, and field 1512 containing a listing of available spots. Spotless information fields are hit-count field 152 and discovery field 153.

The hit-count field 152 keeps track of how often certain spots have been activated or accessed. The hit count field contains information relating to billing concepts of the AB 140.

The discovery field 153 contains information such as entries referring to geolocation and security keys. The geolocation entry enables proper selection of advertisements national content, regional content, and local content. For example, showing an advertisement for a limousine service based on the East cost of the United States would have only very limited impact when embedded in games played on a single user city located at the West coast of the United States. On the other hand, advertisement of a car rental company with nationwide presence is only to a limited degree dependent on geolocation. The security entry provides access to security keys. This feature is related to so-called “denial-of-service” attacks characterized by an explicit attempt by attackers to prevent legitimate users of a service from using that service. Examples include attempts to flood a network, thereby preventing legitimate network traffic attempts to disrupt connections between two machines, thereby preventing access to a service, attempts to prevent a particular individual from accessing a service, attempts to disrupt service to a specific system or person, among others. Not all service outages, even those that result from malicious activity, are necessarily denial-of-service attacks. Other types of attack possibly include a denial of service as a component, but the denial of service may be part of a larger attack. The security entry within the inventory 150 provides for effective means to take effective measures against such destructive services.

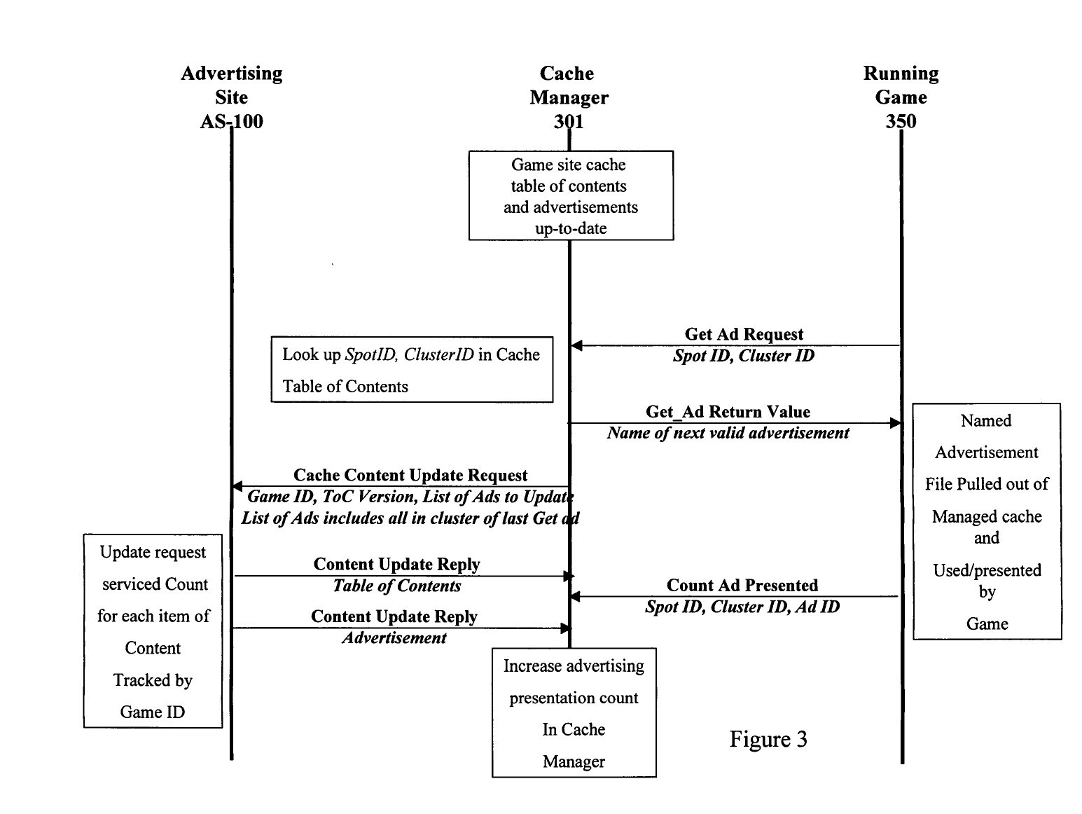

Referring now to FIG. 3, a method for spot registration and spot selection according to the instant invention is shown, the spots relating to advertising spots within a gaming environment. In step 301, a game is provided comprising a plurality of m spots. Preferably, the game is related to an interactive web-based gaming activity. Further preferably, the plurality of n spots relates to display of advertisements within the gaming environment. Preferably, a gaming provider provides the game. In step 302, the game is registered with an advertisement broker. By registering the game with an advertisement broker, the game is available for licensing for a period of time by a reach engine. The gaming provider further registers a number of m spots with the advertisement broker, step 303. Here, the number of registered spots is equal to or less than the number of available spots, m≦n. The gaming provider next selects a subset of m spots from the plurality of n available spots, step 304. The subset of m spots becomes available for advertising for a reach engine that has licensed for a period of time the game in which the subset of m spots is contained. The steps of registering a number of m spots and selecting a subset of m spots are also referred to as enabling a subset comprising m spots for advertising. The subset of m spots is then populated with advertisements, step 305. This step typically takes place whenever the game containing the subset of m spots is played. In a decision step 306, it is decided whether the subset of m spots is to be changed. This decision is for example based on a hit-count associated with a certain spot. If a hit-count analysis reveals that a certain spot does not receive a certain numbers of hits, this spot is exchanged against another spot. Optionally, this decision is based on certain permutation rules, as to populate all of the n available spot in approximately equal manner. Further optionally, permutations of spot subsets are systematically applied, and a corresponding hit-count is monitored. This way, the most successful subset of m spots in terms of hit-counts is determined. A person of skill in the art envisions other applicable success rate measures. The decision step is either executed at the end of a registration time for a game, in connection with a decision whether the registration of the game is to be extended, or it is executed during the registration life of a game. Further optionally, the decision step is executed while the game containing the plurality of n spots is played. If the decision step is positively answered, the procedure steps back to step 304. Selection rules for subset selection apply, and are preferably based on success rates and permutation rules as indicated above. The step of changing a subset of spots is also referred to disabling a subset of spots for advertising and enabling another subset of spots for advertising. If the decision step is negatively answered, an end of procedure is reached in step 307.

The gaming broker concept as exemplified by AB 140 as an embodiment of the instant invention is not restricted to advertising, but is possibly applicable to other areas as well. For example, a broker system in accordance with an embodiment of the instant invention is possibly used in order to manage and/or administer dynamic gaming contents. New and advanced gaming features such as new monsters in a fantasy game, or new car models in a car racing game are optionally distributed using a broker system. A person of skill in the art understands how the gaming broker concept according to the instant invention is properly extended to other areas as well.

Of course, the method for enabling and disabling of spots is also applicable to non-broker mediated advertising systems. For example, a system is developed wherein the advertisements are served from a centralized advertisement server of a game publishing company for its own games.

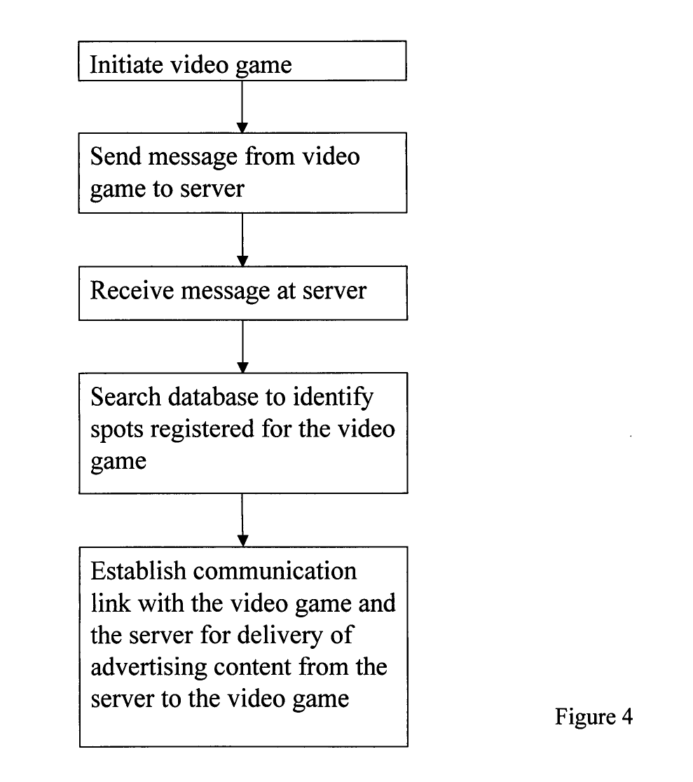

Referring to FIG. 4, an advertising enabled video game is initiated on a workstation. During the start-up phase of the game execution, a message is transmitted to an advertisement server. The message includes information for setting up a communication link with the device on which the game is executed. Further, the message includes data relating to the game in execution and preferably information relating to the game player such as information usable for determining geographic information relating to where the game is being executed.

The advertisement server upon receiving the message establishes a communication link with the system on which the game is executing and searches a database accessible to the advertisement server to determine a plurality of records relating to the game. The records provide data relating to a number of advertisement spots within the game, a type of each spot, a status of each spot, and content for each spot. For those spots that are enabled, advertisement content is then transmitted to the system on which the game is executing.

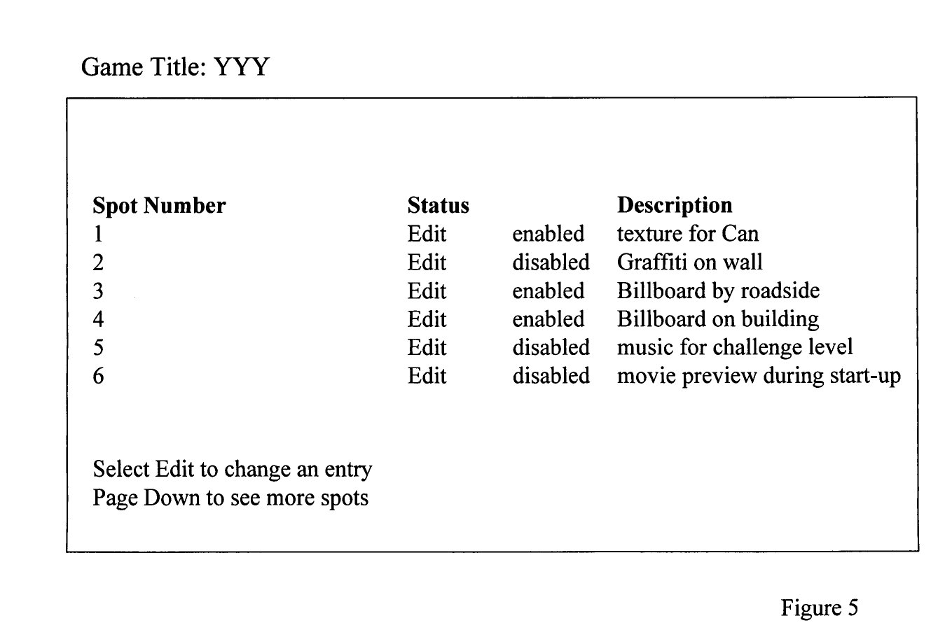

Referring to FIG. 5, a display is shown, showing a listing of spots for a game. The display is useful with the method of FIG. 4 and with an Advertisement broker of the earlier embodiment. Each spot is listed and its status—enabled or disabled—is indicated by a checkbox. The display allows a user with access to the database to select advertisement spots to enable or disable. When a message is received, the database is accessed and, as such, any game played subsequent to a change will reflect the newly enabled/disabled advertisement spots. Alternatively, the database is accessed during game execution as well to vary the advertisement spots in dependence upon a status thereof within the database.

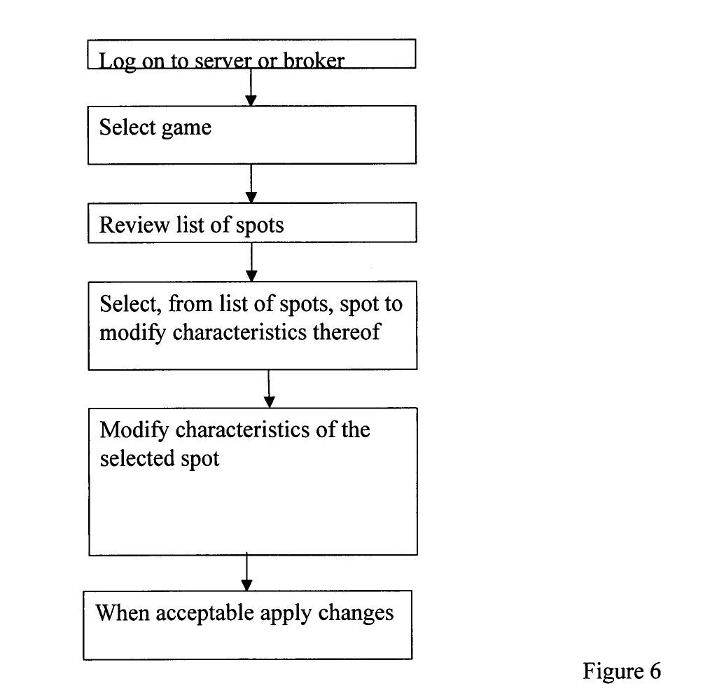

Referring to FIG. 6, a simplified flow diagram of an embodiment for use with FIG. 5 is shown. A game publisher logs onto a advertisement server or a broker system. Once logged onto the system, the game publisher is provided with a listing of all of their published games that are registered with the advertisement server or with the broker. The game publisher then selects a game from the list of games and is shown the spots within that game that are registered. For each spot, spot details are displayed. Though the spot details are highly dependent upon the needs of each publisher, commonly they include spot type, spot status in the form of enabled or disabled, type of suitable advertisement in the form of audio, video, texture, object, or image, and so forth. The game publisher is free to modify the spot details as required and to enable or disable the spots as desired. Thus, when a game is shipped, the game may have a first set of spots enabled based on the creative director of the game and his/her views. Once the game is being played, real user data is usable to determine spots that would be better enabled and those that are better disabled. Alternatively, spots are enabled/disabled based on other factors such as the time since the game was released, the success of the game, the financial needs of the publisher, the cost of the game, which may vary over time, and pressure provided by the advertisers to enable certain spots.

Once the game publisher is satisfied with the changes that have been made, they are applied and the advertisement server and/or the broker are updated to reflect the changes. In this way, the in game placement of content in the form of advertisements is dynamic both in the dynamic delivery of the content and in the dynamic modification of spot details even after a physical medium based game is shipped. Of course the invention also applies to on-line games allowing a publisher control over spot details without requiring knowledge or experience in the game development and design.

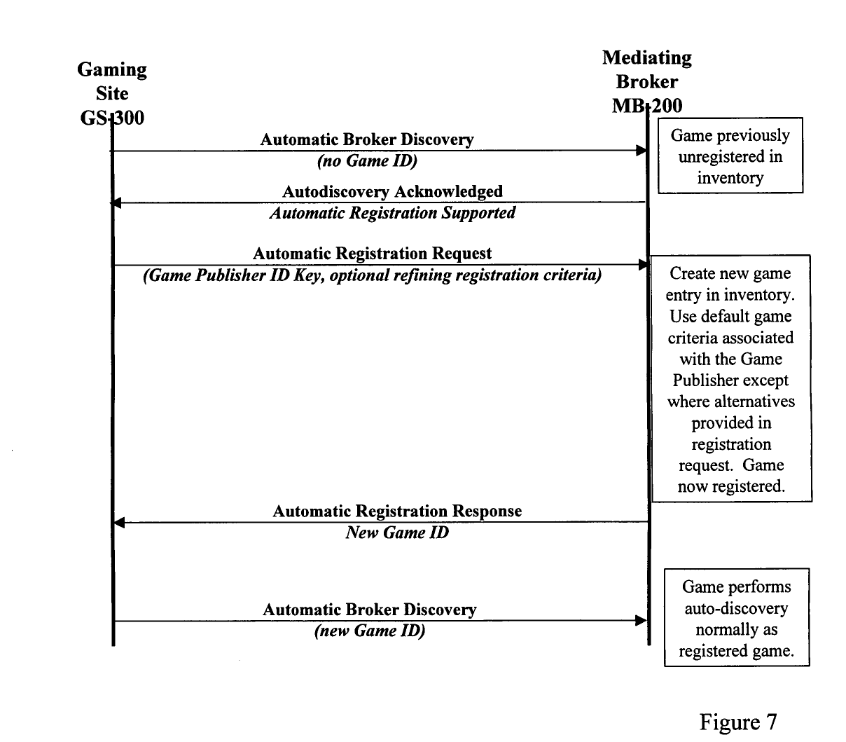

Referring now to FIG. 7, a previously unregistered with the broker, advertising enabled video game is initiated on a workstation. During the startup phase of the game execution a message is transmitted to the broker site indicating that the game is absent an associated game identifier, it is unregistered. The broker site replies to the game indicating that it does support automatic game registration. The game proceeds to request automatic registration. The game provides to the broker a key uniquely identifying the game producer or publisher with whom the newly registered game is to be associated. The game optionally provides a set of criteria defining details of the game registration or alternatively chooses to accept the default criteria as set out by information already associated with the game producer at the broker site. At the broker site, an entry is automatically created for the game within the inventory associated with the broker site with the criteria for the game set either as specified in the request or by the defaults available to the broker. A message is transmitted notifying the game of success of this event and supplying the game with an identifier when necessary for uniquely identifying the game within the broker mediated gaming environment. Alternatively, the unique identifier is assigned by the publisher, and as such, is known to the game prior to the auto-registration process. The game itself is now available for lease from the inventory in the same manner a manually registered game title.

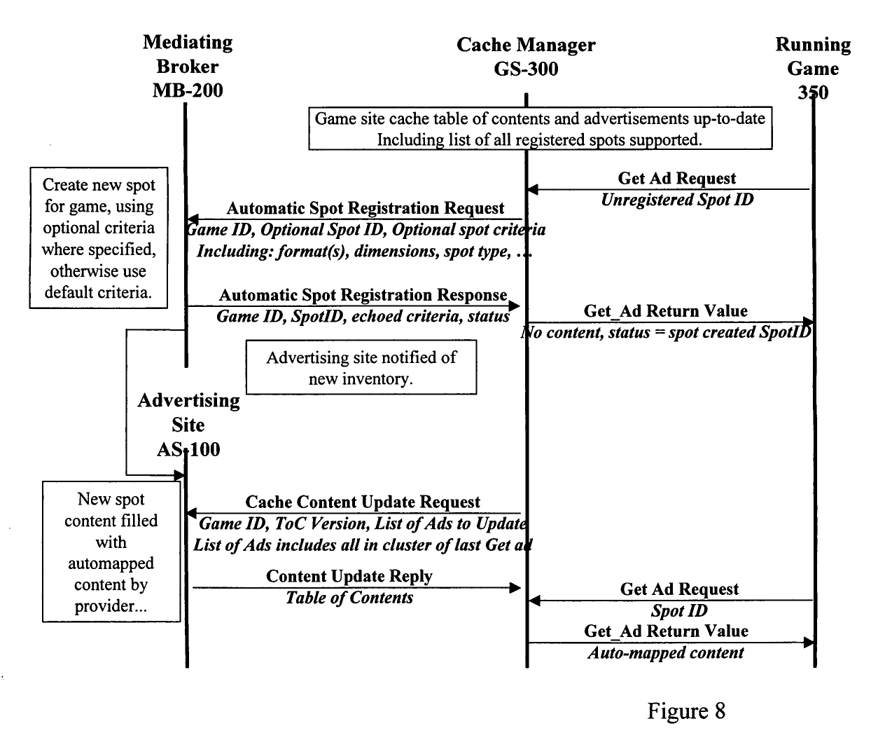

Referring now to FIG. 8, an advertising enabled game which is registered with the inventory of a broker mediated gaming environment is in the process of being played. The game may or may not have already contacted an advertising site and may or may not have already received advertising content. At some point during the game play the game requests content for a spot which has not before this time been registered or provisioned. The request for an unregistered spot is detected and the broker site is notified. The broker replies to the game indicating whether or not automatic spot creation is supported by the broker. Where automatic spot creation is supported, the game requests creation of the spot. The criteria defining the spot, including but not limited to the spot identifier, the cluster identifier, type of spot it is, the type and format of content acceptable for the spot, the dimensions defining the spot, whether it is to start as enabled or disabled and any other criteria necessary to describe the spot and contents needed to fill it may be provided by the game, or the game may choose to accept the default criteria provided for by the broker. The default criteria provided for by the broker is based on pre-defined criteria associated with the game publisher, optionally with the game itself, in the database available to the broker. Where no spot identifier is designated by the game in the automatic creation request, the spot identifier is generated by the broker, ensuring uniqueness within the game. The newly created spot is entered into the inventory associated with the originating game in the broker mediated gaming environment. The game is notified of the successful spot creation, along with the criteria as they were entered in the inventory. Where the game, which has just triggered an automatic spot creation, has an active lease by an advertising provider and the newly created spot is enabled for advertising, the broker optionally chooses to notify the advertising site of the updated inventory. The notified advertising site optionally chooses to automatically associate appropriate advertising content against the newly created spot. Preferably, the content meets the criteria outlined for the spot and would come from a set of pre-approved advertising content for the game. When the next instance of the game in question requests content from the advertising site, the automatically created spot and its newly associated content are eligible for the response. Alternatively, when a known content request is received, the known content request for a type of content that is well known such as an industry standard format, the spot is automatically created in accordance with the known spot characteristics absent receiving further communication from the game.

According to the above embodiments, the games communicate via a wide area network directly with the advertisement server to retrieve advertisements. On such a system, the ability to enable and disable advertisement spots dynamically after a game has already been shipped to a customer is highly advantageous.

Although the present invention has been described with respect to specific embodiments thereof, various changes and modifications are optionally carried out by those skilled in the art without departing from the scope of the invention. Therefore, it is intended that the present invention encompass such changes and modifications as fall within the scope of the appended claims.

1. A system comprising:
a broker site connected to an access aggregation network for registering games and for licensing registered games for receiving advertising from advertising sites in communication with the access aggregation network, the broker site having data stored therein for maintaining an inventory of characteristics of registered games, the characteristics relevant for advertising.

2. A system according to claim 1 comprising a processor for receiving game data and spot data relating to the game, the processor for storing within the inventory, the spot data in association with the game.

3. A system according to claim 1 comprising a processor for receiving game data and spot data relating to the game, the processor for automatically registering the game.

4. A system according to claim 1 comprising a processor for receiving game data and spot data relating to the game, the processor for automatically registering the game and for automatically creating within the inventory an entry corresponding to a spot within a game and automatically registering the spot.

5. A system according to claim 1, wherein the games registered at the broker site each have a characteristic relating to a spot relevant to advertising.

6. A system according to claim 5, wherein the spot is a spot selected from a group consisting of a hard spot, a soft spot, an enabled spot, and an available spot.

7. A system according to claim 6, wherein the inventory of characteristics comprises data relating to available spots.

8. A system according to claim 6, wherein the inventory of characteristics comprises data relating to enabled spots.

9. A system according to claim 1, comprising:
receiving communication from at least one of a game in execution and a server for distributing advertising content to a game in execution, wherein the inventory of characteristics comprises demographic information relating to games to which advertising content is provided.

10. A system according to claim 9, wherein the demographic information includes geo-location information relating to a location at which a game is in execution.

11. A system according to claim 1 comprising: receiving communication from at least one of a game in execution and a server for distributing advertising content to a game in execution, wherein the inventory of characteristics comprises security information relating to at least one of the game in execution and the server.

12. A system according to claim 1, wherein the inventory of characteristics comprises impression-count information relating to each spot, the impression count information based on a number of impressions of advertising content upon a player of a game in execution and having communicated with the broker.

13. A method for spot management within a gaming environment supporting in game advertising comprising:
providing a game comprising a plurality of spots, each spot for supporting dynamic content delivery for being inserted within the spot during execution of the game;
registering the game comprising the plurality of spots with one of a broker site and a server site, the registered game for during execution receiving content for insertion into spots from a source external to the system on which the game executes during execution thereof; and
enabling fewer than all of the plurality of spots for advertising.

14. A method according to claim 13 comprising receiving game data and spot data relating to the game;
and storing within the inventory, the spot data in association with the game.

15. A method according to claim 13 comprising:
receiving game data and spot data relating to the game;
automatically registering the game.

16. A method according to claim 13 comprising:
receiving game data and spot data relating to the game,
automatically registering the game;
automatically creating within the inventory an entry corresponding to a spot within a game; and
automatically registering the spot.

17. A method according to claim 16 comprising:
automatically registering advertising content against the automatically registered spot.

18. A method according to claim 13, wherein the plurality of spots are selected from a group containing soft spots and hard spots.

19. A method according to claim 13, wherein the game is registered with a broker site.

20. A method according to claim 19, wherein enabling is performed by modifying data stored within the broker site.

21. A method according to claim 20, wherein the data modified is stored within a database including characteristic data relating to a plurality of spots within each of a plurality of games.

22. A method according to claim 13, wherein the game is registered with a server site.

23. A method according to claim 22, wherein enabling is performed by modifying data stored within the server site.

24. A method according to claim 23, wherein the data modified is stored within a database including characteristic data relating to a plurality of spots within each of a plurality of games.

25. A method according to claim 13 comprising modifying characteristics of spots within a game, the spots supporting insertion of advertising content therein, modifying performed after the game has been distributed without modifying game executable code of the game.

26. A method according to claim 13 comprising:
after a game has already been released
disabling an enabled spot, and
enabling another spot for advertising.

27. A method according to claim 26, wherein the steps of disabling and enabling of spots are performed automatically.

28. A method according to claim 27 wherein the automatic disabling and enabling of a known spot is performed in dependence upon a reported count of a number of times the known spot is impressed upon a player of the game.

29. A method according to claim 26, wherein the steps of disabling and enabling are performed while a game comprising spots is being executed.

30. A system comprising:
a server for controlling in game advertising for games registered therewith;
a database accessible to the server, the database including entries relating a plurality of games to a plurality of spots, the plurality of spots each having an associated game and associated advertising data, the associated advertising data for use in retrieving advertising data for being communicated to the associated game for insertion within each spot;
a transceiver for communicating with a system on which a game is executed during execution thereof.

31. A system according to claim 30 comprising:
data stored within the database indicative of a status of at least some spots, the status comprising enabled and disabled.

32. A system according to claim 31 wherein the server comprises means for modifying a status of a spot after a game is published and absent modifying the game executable code of the game for which the spot status is indicated.

33. A system comprising:
a broker site connected to an access aggregation network for registering games and for licensing registered games for receiving advertising from advertising sites in communication with the access aggregation network, the broker site having data stored therein for maintaining an inventory of characteristics of registered games, the characteristics relevant for advertising, the broker for receiving a communication relating to a game and for determining an advertising site and advertising data for provision from the advertising site in response to the communication, the advertising site other than the broker site.
